(19) United States
(12) Patent Application Publication
(10) Pub. No.: US 2017/0100976 A1
(43) Pub. Date: Apr. 13, 2017

(54) AXLE/SUSPENSION SYSTEM TOWER MOUNT

(71) Applicant: HENDRICKSON USA, L.L.C., Itasca, IL (US)

(72) Inventors: Damon Elwood Dilworth, Channahon, IL (US); Michael Paul Bloink, Romeoville, IL (US); Matthew Edward Michael DiCianni, Mokena, IL (US); Jay D. White, Massillon, OH (US)

(21) Appl. No.: 15/287,883

(22) Filed: Oct. 7, 2016

Related U.S. Application Data
(60) Provisional application No. 62/240,133, filed on Oct. 12, 2015.

(51) Int. Cl. B60G 9/02; B60G 99/00; B60T 13/26

(52) U.S. Cl. CPC B60G 9/02; B60T 13/26; B60G 99/002; B60G 2204/4306; B60G 2206/72; B60G 2300/026

(57) ABSTRACT

An axle/suspension system tower mount for a heavy-duty vehicle which mounts a force reacting suspension component attached to the vehicle frame members to the axle of the axle/suspension system. The tower mount includes an axle wrap system which attaches the tower mount to the axle of the axle/suspension system at a location inboard of the axle/suspension system suspension assemblies. The axle/suspension system tower mount provides mounting support for components of an air brake system, including cam shaft assemblies, brake air chambers, and mounting brackets thereof.

### CROSS-REFERENCE TO RELATED APPLICATION

This application claims the benefit of U.S. Provisional Patent Application Ser. No. 62/240,133, filed Oct. 12, 2015.

### BACKGROUND OF THE INVENTION

Technical Field

The invention relates to the art of axle/suspension systems for heavy-duty vehicles. More particularly, the invention relates to non-drive axle suspension assembly mounts for axle/suspension systems of heavy-duty vehicles. Even more particularly, the invention is directed to an integrated axle/suspension system tower mount used with a wrap system on an axle of a heavy-duty vehicle, which supports mounting of the suspension assembly, camshafts, and brake air chambers, thereby eliminating the need to weld such components directly to the axle. Attaching the suspension assembly, camshafts, and brake air chambers to the tower reduces axle stress, allowing a thinner and lighter round axle to be utilized in a non-drive axle/suspension system, thereby reducing the vehicle weight, increasing the vehicle fuel economy, and reducing vehicle operating costs.

Background Art

The use of air-ride axle/suspension systems has been very popular in the heavy-duty truck and tractor-trailer industry for many years. Air-ride trailing and leading arm non-torque reactive-type axle/suspension systems also are often used in the industry, for example, with heavy-duty trucks. Although such axle/suspension systems can be found in widely varying structural forms, generally their structure is similar in that each system typically includes a pair of suspension assemblies. In some heavy-duty vehicles, the suspension assemblies are connected directly to the primary frame of the vehicle. In other heavy-duty vehicles, the primary frame of the vehicle supports a subframe, and the suspension assemblies connect directly to the subframe. For those heavy-duty vehicles that support a subframe, the subframe can be non-movable or moveable, the latter being commonly referred to as a slider box, slider subframe, slider undercarriage, or secondary slider frame. For the purposes of convenience and clarity, reference herein will be made to main members, with the understanding that such reference is by way of example, and that the present invention applies to heavy-duty vehicle axle/suspension systems suspended from main members of primary frames, moveable subframes and non-moveable subframes.

Each suspension assembly of a non-torque reactive-type axle/suspension system typically includes a longitudinally extending torque rod assembly. Each torque rod assembly is general located adjacent to and below a respective one of a pair of spaced-apart longitudinally extending main members and one or more cross members which form the frame of the vehicle. More specifically, each torque rod assembly is pivotally connected at one of its ends to a hanger, which in turn is attached to and depends from a respective one of the main members of the vehicle. An axle extends transversely under the vehicle frame and is attached to each torque-rod assembly by means known in the art. The torque-rod assembly may extend rearwardly or frontwardly from the pivotal connection relative to the front of the vehicle, thus defining what are typically referred to as trailing arm or leading arm axle/suspension systems, respectively. However, for purposes of the description contained herein, it is understood that the term “trailing arm” will encompass torque rod assemblies, which extend either rearwardly or frontwardly with respect to the front end of the vehicle. The end of each torque rod assembly opposite from its pivotal connection to the hanger is typically connected to a bellows air spring or its equivalent, which in turn is connected to a respective one of the main members.

The axle/suspension system of the heavy-duty vehicle acts to cushion the ride, dampen vibrations, and stabilize the vehicle. More particularly, as the vehicle is traveling over-the-road, its wheels encounter road conditions that impart various forces, loads, and/or stresses, collectively referred to herein as forces, to the respective axle on which the wheels are mounted, and in turn, to the suspension assemblies that are connected to and support the axle. In order to minimize the detrimental effect of these forces on the vehicle as it is operating, the axle/suspension system is designed to react or absorb at least some of the forces.

These forces include vertical forces caused by vertical movement of the wheels as they encounter certain road conditions, fore-aft forces caused by acceleration and deceleration of the vehicle, and side-load and torsional forces associated with transverse vehicle movement, such as turning of the vehicle and lane-change maneuvers. In order to address such disparate forces, axle/suspension systems have differing structural requirements. More particularly, it is desirable for an axle/suspension system to be fairly stiff in order to minimize the amount of sway experienced by the vehicle and thus provide what is known in the art as roll stability. However, it is also desirable for an axle/suspension system to be relatively flexible to assist in cushioning the vehicle from vertical impacts, and to provide compliance so that the components of the axle/suspension system resist failure, thereby increasing durability of the axle/suspension system.

In non-torque reactive-type axle/suspension systems, torque box assemblies have been utilized to achieve the desired balance of stiffness and flexibility of the axle/suspension system, as well as to provide additional reaction to and control of the various forces imparted on the axles of the heavy-duty vehicle, as is known in the art. Specifically, the torque box assembly reacts to the vertical air spring loads, provides longitudinal control to the axle/suspension system over the top of the vehicle axle to resist braking/acceleration loads, provides roll stiffness and acts as the core roll resisting feature, provides lateral control to the axle/suspension system to resist cornering or lateral loading, maintains axle location in relation to the vehicle main members, and also helps prevent undue yaw and axle wind-up.

In heavy-duty vehicle non-torque reactive-type axle/suspension systems which employ torque box assemblies, the axles can be either driven or non-driven. For example, in a tandem axle/suspension system configuration for heavy-duty truck and tractor applications, it is sometimes desirable to have the rearmost axle be a non-driven axle, such as when a 6×2 tag axle configuration is desired. In prior art heavy-duty truck and tractor axle/suspension systems employing a non-torque reactive-type axle/suspension system which includes a torque box assembly attached to a non-driven axle, a round axle typically has not been utilized. Because round axles have a generally thinner construction compared to drive axles, welding of the torque assembly directly to a round axle can potentially create significant stress risers and local mechanical property changes in the axle, as is generally well known in the art. These stress risers and local mechanical property changes in the axle can in turn potentially reduce the durability/life expectancy of the axle and any bracket-to-axle connection.

In addition, it is often desirable to incorporate an air braking system into the axle/suspension system to assist in vehicle braking. Conventional heavy-duty vehicle brake systems typically include a brake assembly for each suspension assembly and its associated wheel. The brake assembly components typically include a brake air chamber, a pushrod, a slack adjuster, and an S-cam assembly. The S-cam assembly includes a cam shaft and an S-cam which is utilized to move brake shoes against a brake drum of the vehicle wheel to decelerate the vehicle. The cam shaft typically is supported at each of its ends. More particularly, the outboard end of the cam shaft is supported by a brake spider which in turn is mounted on the axle. The inboard end of the cam shaft is supported by a cam shaft bracket. The brake spider and the cam shaft bracket each support a bearing to enable rotation of the cam shaft during operation of the vehicle. Generally, the cam shaft bracket is welded directly to the axle to provide stability to the inboard end of the cam shaft and its bearing, and in turn to the entire brake assembly. The brake air chamber is also typically mounted on the axle with a brake air chamber bracket, which is also welded directly to the axle in certain applications. Although welding of the brake air chamber bracket and cam shaft bracket directly to the axle provides increased stability to the braking system, axle stress in addition to the stresses from welding the torque box assembly to the axle can be experienced.

Due to the stresses induced on axle/suspension systems which employ a non-drive axle and a torque box assembly and/or an air brake system, traditional “dead axles”, or non-drive axles which utilize the same architecture as standard drive axles with all of the internal gearing and shafts removed, have been employed as such axles have a generally thicker construction as compared to round axles. In such applications, the torque assembly is generally attached directly to the axle of the associated axle/suspension system by welds. In addition, if the axle/suspension system utilizes an air brake system, the mounting components of the brake system are typically welded directly to the axle.

Although prior art dead axles can withstand the stress of welding the torque box assembly and/or brake system components directly to the axle, these axles add unnecessary weight to the axle/suspension system as compared to round axles because dead axles still have a large axle housing in the center of the axle that typically is used to house the axle differential in a drive axle, but does not serve a purpose when the internal gearing and shafts have been removed in a non-drive axle application.

An additional disadvantage of utilizing a dead axle in heavy-duty vehicle non-torque reactive-type axle/suspension systems which include a braking system incorporated into the axle/suspension system, is the nature in which brake components must be attached to the axle to provide braking to wheels attached to the axle. In prior art non-torque reactive-type axle/suspension systems which utilize a dead axle, because such large housings are located at the center of such axles, the brake air chamber brackets and S-cam brackets must typically be mounted near the outboard ends of the axle. In addition, because of the increased axle/suspension system weight with use of a dead axle, the bracketry used to mount air brake system components is typically constructed of thinner gauge materials in order to attempt to limit the axle/suspension weight. The use of thinner gauge materials for the air brake system component bracketry can potentially lead to higher deflections between the brake air chamber mount and the cam mount under high application pressure, for example, at 100 psi, which can in turn reduce brake system performance.

Therefore, a need exists in the art for a structure for a non-torque reactive-type axle/suspension system of a heavy-duty vehicle that mounts the torque box assembly to the axle, as well as allows braking system components to be attached to or integrated with the structure, thereby reducing axle stress by minimizing welds on the axle and allowing a thinner, lighter round axle to be utilized for non-driven applications. The axle/suspension system tower mount of the present invention satisfies these needs, as will be described below.

### BRIEF SUMMARY OF THE INVENTION

An objective of the present invention is to provide a structure for heavy-duty vehicles that mounts a torque box assembly of a non-torque reactive-type axle/suspension system to the axle with reduced stress on the axle.

Another objective of the present invention is to provide a structure for heavy-duty vehicles that provides a mounting structure which allows air brake components to be attached to the structure in order to minimize welding of components directly to the axle, thereby reducing axle stress and allowing a lighter round axle to be utilized in the axle/suspension system.

Yet another objective of the present invention is to provide a structure for heavy-duty axle/suspension systems that provides a stable, sturdy structure for mounting air brake system components to improve brake system performance.

These objectives and others are obtained by the mounting structure for a heavy-duty vehicle axle/suspension system and brake system which includes at least one axle wrap disposed about and rigidly attached to an axle of the vehicle axle/suspension system; and a mount assembly rigidly attached to the at least on axle wrap and being operatively connected to a force reacting suspension component of the axle/suspension system, the mount assembly providing a support structure for mounting at least one component of an air brake system.

### BRIEF DESCRIPTION OF THE SEVERAL VIEWS OF THE DRAWINGS

The preferred embodiment of the present invention, illustrative of the best mode in which Applicant has contemplated applying the principles of the present invention, is set forth in the following description and is shown in the drawings, and is particularly and distinctly pointed out and set forth in the claims.

FIG. 1 is a driver side rear perspective view of a prior art non-torque reactive-type axle/suspension system for a heavy-duty vehicle, showing the torque box assembly attached to a dead or non-drive axle;

FIG. 2 is a driver side rear perspective view of a non-torque reactive-type axle/suspension system for a heavy-duty vehicle, with the main members of the vehicle frame shown in phantom lines, incorporating a preferred embodiment suspension axle/suspension system tower mount of the present invention;

FIG. 3 is a driver side front perspective view of the axle/suspension system incorporating the preferred embodiment axle/suspension system tower mount of FIG. 2;

FIG. 4 is a rear elevational view of the axle/suspension system incorporating the preferred embodiment axle/suspension system tower mount of FIG. 2;

FIG. 5 is a front elevational view of the axle/suspension system incorporating the preferred embodiment axle/suspension system tower mount of FIG. 2;

FIG. 6 is a driver side rear perspective view of a portion of the axle/suspension system of FIG. 2, showing the attachment of the preferred embodiment axle/suspension system tower mount of the present invention to the axle, as well as attachment of the air brake components to both the tower mount and the axle;

FIG. 7 is a rear elevational view of the portion of the axle/suspension system and preferred embodiment axle/suspension system tower mount of FIG. 6;

FIG. 8 is a driver side front perspective view of the portion of the axle/suspension system and preferred embodiment tower mount of FIG. 6; and

FIG. 9 is a front elevational view of the portion of the axle/suspension system and preferred embodiment tower mount of FIG. 6.

Similar numerals refer to similar parts throughout the drawings.

### DETAILED DESCRIPTION OF THE INVENTION

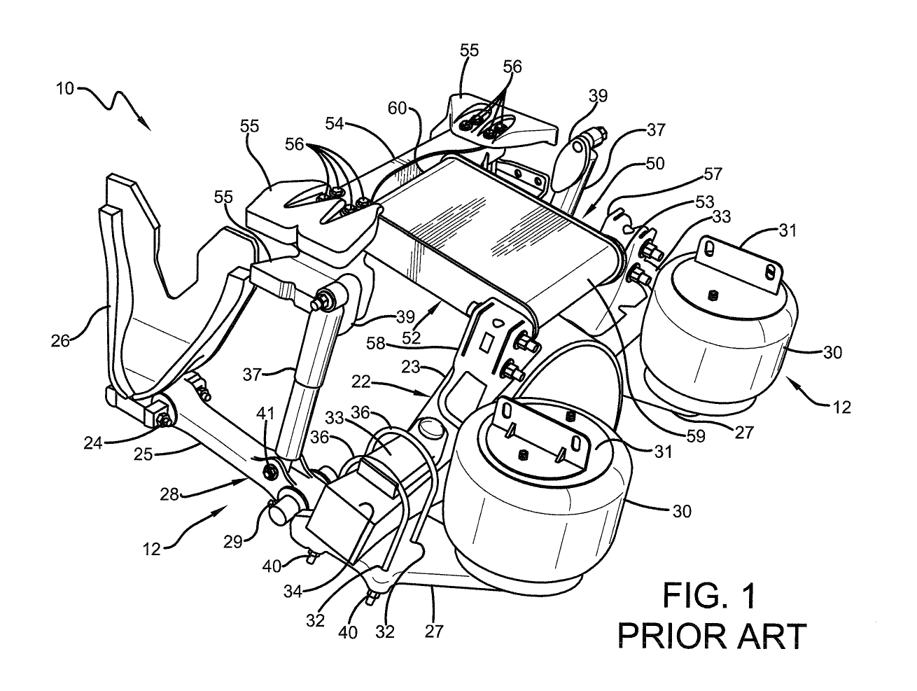

In order to better understand the integrated axle/suspension system tower mount for a heavy-duty vehicle of the present invention and the environment in which it operates, a prior art non-torque reactive-type trailing arm axle/suspension system for heavy-duty vehicles is indicated generally at 10, and is shown in FIG. 1. Axle/suspension system 10 is of the general type described and shown in U.S. Pat. No. 6,527,286, and assigned to the Boler Company.

With reference to FIG. 1, axle/suspension system 10 is attached to a heavy-duty vehicle (not shown) on a pair of transversely spaced vehicle frame main members (not shown) and/or cross-members (not shown) which extend longitudinally and transversely, respectively, under the vehicle. Axle/suspension system 10 generally includes an axle 22, a pair of suspension assemblies 12, and a torque box assembly 50. As will be appreciated, with respect to axle/suspension system 10, the majority of components positioned on one side of the vehicle have correspondingly similar components positioned on the other side of the vehicle. Accordingly, in this description, when reference is made to a particular axle/suspension system component, it is to be understood that a similar component is present on the opposite side of the vehicle, unless otherwise apparent.

Each suspension assembly 12 includes a frame hanger 26 mounted to the outboard surface of the vehicle main members (not shown). Suspension assembly 12 further includes a longitudinally extending torque rod assembly 28. Torque rod assembly 28 has a two-component construction and includes a torque rod 25 and a lower air spring bracket 27. Torque rod 25 is pivotally connected at its forward end to frame hanger 26 via a first torque rod bushing 24. Torque rod 25 is pivotally connected at its rearward end to lower air spring bracket 27 via a second torque rod bushing 29. Lower air spring bracket 27 extends rearwardly from its pivotal connection (not shown) to torque rod 25. Lower air spring bracket 27 is formed with two pairs of longitudinally aligned openings 32. An air spring 30 is attached to the top surface of the rearward end of lower air spring bracket 27. An air spring mounting bracket 31 is attached to the top of air spring 30, and in turn, is attached to the vehicle main member (not shown). Axle/suspension system 10 includes a shock absorber 37 pivotally connected at its upper end to an upper shock absorber frame bracket 39 mounted to the main member. Shock absorber 37 is pivotally connected at its lower end to torque rod 25 by a fastener 41 and provides damping to axle/suspension system 10, as is known in the art.

Axle 22 includes a differential housing 23 and a pair of axle arms 34 extending outboardly from the housing. Axle 22 is a non-drive or dead axle, in that all of the internal gearing typically used in a drive axle (not shown) has been removed from differential housing 23. A top pad 33 is attached to the top surface of each axle arm 34. Each axle arm 34 is attached to the top surface of its respective lower air spring bracket 27 by a pair of U-bolts 36. Specifically, each U-bolt 36 is disposed around top pad 33 and axle arm 34, and extends through a respective one of the pair of longitudinally aligned openings 32, and captures axle 22 between lower air spring bracket 27 and top pad 33 by tightening nuts 40. Axle 22 extends transversely under the vehicle (not shown) so that each axle arm 34 is secured to a respective lower air spring bracket 27. An axle spindle (not shown) is attached to, and extends outboardly from, the outboard end of each axle arm 34. During vehicle operation, a wheel hub (not shown) and a tire (not shown) are mounted on the axle spindle in a manner known in the art.

Torque box assembly 50 is of the type described and shown in U.S. Pat. No. 6,527,286, and assigned to the Applicant of the present invention, Hendrickson U.S.A., L.L.C. Torque box assembly 50 provides roll stability to axle/suspension system 10, as is known in the art, and will now be described.

Torque box assembly 50 generally includes a body 52, a cross member 54, a tall axle bracket 57, and a short axle bracket 58. Body 52 includes a first hollow steel tube 60 welded to the front end of the body. A second hollow steel tube 59 is welded to the rear end of body 52. A bonded rubber bushing 53 is disposed into each outboard facing end of first hollow steel tube 60 and second hollow steel tube 59. A metal rod (not shown) is disposed transversely through each of first hollow steel tube 60 and second hollow steel tube 59, as well as their respective bushings 53, so that a portion of the rod extends outboardly of each tube end. Each rod end (not shown) extending outboardly from first hollow steel tube 60 is pivotally connected to cross member 54 in a manner known in the art. A pair of gussets 55 are attached to each outboard end of cross member 54 by a plurality of bolts 56. Each pair of gussets 55 are in turn attached to the inboard surface of a respective vehicle main member and/or cross member (not shown) to secure torque box assembly 150 to the vehicle frame (not shown).

The driver side rod end (not shown) extending outboardly from second hollow steel tube 59 is pivotally connected to short axle bracket 58 in a manner known in the art. Short axle bracket 58 is in turn attached to differential housing 23 of axle 22 by welds. The curb side rod end extending outboardly from second tube 59 is pivotally connected to tall axle bracket 57. Tall axle bracket 57 is in turn attached to differential housing 23 of axle 22 by welds (not shown). Together, short axle bracket 58 and tall axle bracket 57 link/connect torque box assembly 50 to axle 22. In heavy-duty vehicles featuring a tandem axle/suspension configuration, a second torque box assembly similar to torque box assembly 50 can be attached to cross member 54 so that the torque box assembly extends forwardly from its attachment, with the second torque box assembly in turn being connected to an axle of a leading arm axle/suspension system in a manner similar that described with respect to the trailing arm axle/suspension system 10. Torque box assembly 50 reacts to vertical air spring loads, resists braking/acceleration loads, acts as the core roll resisting feature, resists cornering or lateral loading, and maintains axle location in relation to the vehicle main members, and also helps prevent undue yaw and axle wind-up, as is known in the art.

In addition, in applications in which an air brake system (not shown) is incorporated into axle/suspension system 10, an S-cam bracket (not shown) is welded to the outboard end of each arm 34 of axle 22. An S-cam assembly (not shown) is mounted to the S-cam bracket, and in turn is disposed through a brake spider (not shown) which is disposed around, and/or attached to, the outboard end of axle 22. A brake air chamber (not shown) is attached to either the S-cam bracket, or an additional bracket welded to axle 22. The brake air chamber is operatively connected to the S-cam assembly via a brake air chamber pushrod (not shown). Actuation of the brake air chamber facilitates vehicle braking by forcing the brake air chamber pushrod forward, which in turn causes the S-cam assembly to force a pair of brake shoes (not shown) attached to the brake spider against a brake drum (not shown) of the respective vehicle wheel (not shown) to decelerate the vehicle during operation, as is known in the art.

Although axle 22, being a dead axle, has sufficient strength to tolerate the stress of welding components directly to the axle, including tall axle bracket 57 and short axle bracket 58, as well as brake system components in applications in which an air brake system is utilized, the axle adds unnecessary weight to axle/suspension system 10 as differential housing 23, which no longer houses an axle differential when used as a non-drive axle, serves no purpose when the internal gearing and shafts have been removed. In addition, because differential housing 23 is located near the longitudinal centerline of axle 22, in applications were an air brake system (not shown) is utilized, the brake air chamber brackets (not shown) and S-cam brackets (not shown), or collectively the “brake system mounting brackets”, must be mounted near the outboard ends of the axle and are typically constructed of thinner gauge materials to attempt to limit axle/suspension system weight, which in turn can potentially lead to higher deflections between the brake air chamber mount and the cam mount under high application pressure, for example, at 100 psi, thereby reducing brake system performance.

Therefore, a need exists in the art for a structure for a non-torque reactive-type axle/suspension system for a heavy-duty vehicle that mounts a torque box assembly to the axle, as well as enables braking system components to be incorporated directly into the suspension tower, thereby reducing axle stress by minimizing axle welds and allowing a thinner, lighter round axle to be utilized in non-drive axle applications. The integrated axle/suspension system tower mount of the present invention satisfies these needs, and will now be described.

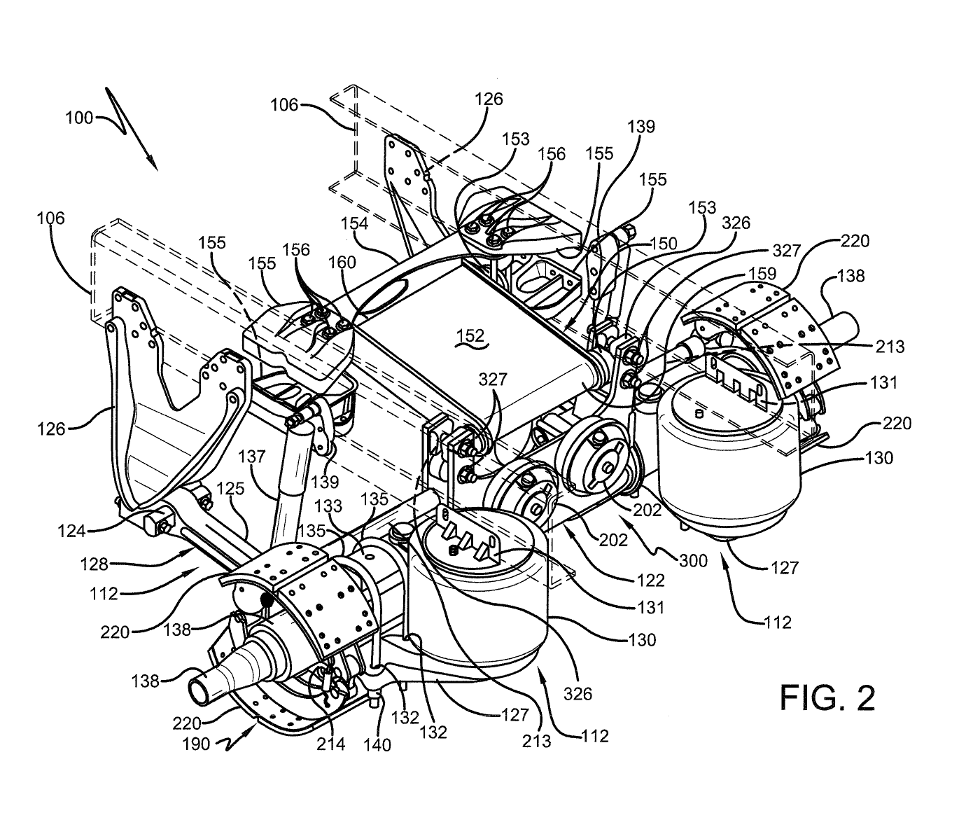

A non-torque reactive-type axle/suspension system for a heavy-duty vehicle, incorporating a preferred embodiment integrated axle/suspension system tower mount 300 of the present invention, is indicated generally at 100 and is shown in FIGS. 2-9. Axle/suspension system 100 is similar in structure and function to that of axle/suspension system 10 previously described, except that axle/suspension system 100 includes a round axle 122 and integrated axle/suspension system tower mount 300 of the present invention.

With reference to FIGS. 2-5, axle/suspension system 100 is attached to a heavy-duty vehicle (not shown) on a pair of transversely spaced parallel vehicle frame main members 106 which extend longitudinally under the vehicle (not shown). Axle/suspension system 100 generally includes a pair of suspension assemblies 112, a torque box assembly 150, and axle 122. As will be appreciated, with respect to axle/suspension system 100, the majority of components positioned on one side of the vehicle have correspondingly similar components positioned on the other side of the vehicle. Accordingly, in this description, when reference is made to a particular axle/suspension system component, it is to be understood that a similar component is present on the opposite side of the vehicle, unless otherwise apparent.

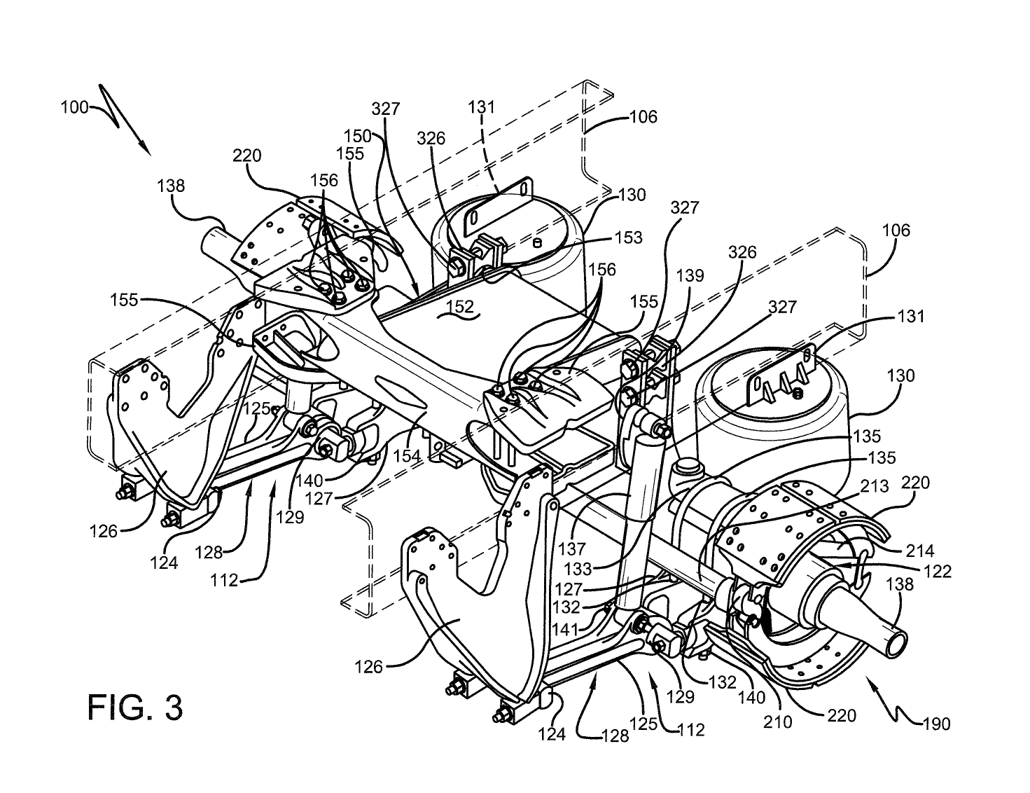

As best shown in FIGS. 2 and 3, each suspension assembly 112 includes a frame hanger 126 mounted to the outboard surface of main members 106. Suspension assembly 112 also includes a longitudinally extending torque rod assembly 128. Torque rod assembly 128 has a two-component construction, and includes a torque rod 125 and a lower air spring bracket 127. Torque rod 125 is pivotally connected at its forward end to frame hanger 126 via a first torque rod bushing 124. Torque rod 125 is pivotally connected at its rearward end to lower air spring bracket 127 via a second torque rod bushing 129. Lower air spring bracket 127 extends rearwardly from its pivotal connection to torque rod 125. Lower air spring bracket 127 is formed with two pairs of longitudinally aligned openings 132. An air spring 130 is attached to the top surface of the rearward end of lower air spring bracket 127 by suitable means (not shown). An air spring mounting bracket 131 is attached to the top of air spring 130, and in turn is attached to main member 106 by suitable means. Axle/suspension system 100 includes a shock absorber 137 pivotally connected at its upper end to an upper shock absorber frame bracket 139 mounted to main member 106 by suitable means. Shock absorber 137 is pivotally connected at its lower end to torque rod 125 by a fastener 141. Shock absorber 137 provides damping to axle/suspension system 100, as is known in the art.

Axle 122 extends transversely beneath the heavy-duty vehicle (not shown) and is attached near its outboard ends to the top surface of each respective lower air spring bracket 127. More specifically, a top pad 133 is configured for attachment near the outboard ends of the correspondingly-shaped top surface of axle 122. A pair of U-bolts 135 are disposed around top pad 133 and axle 122. Each U-bolt 135 extends through a respective one of the pair of longitudinally aligned openings 132, and captures axle 122 between lower air spring bracket 127 and top pad 133 by tightening nuts 140. Axle 122 extends transversely under the vehicle (not shown) so that the outboard ends of the axle are secured to a respective lower air spring bracket 127. An axle spindle 138 is attached to each outboard end of axle 122. Axle spindle 138 extends outboardly from its attachment to axle 122, and during vehicle operation, includes a wheel hub (not shown) and a tire (not shown) mounted on the axle spindle.

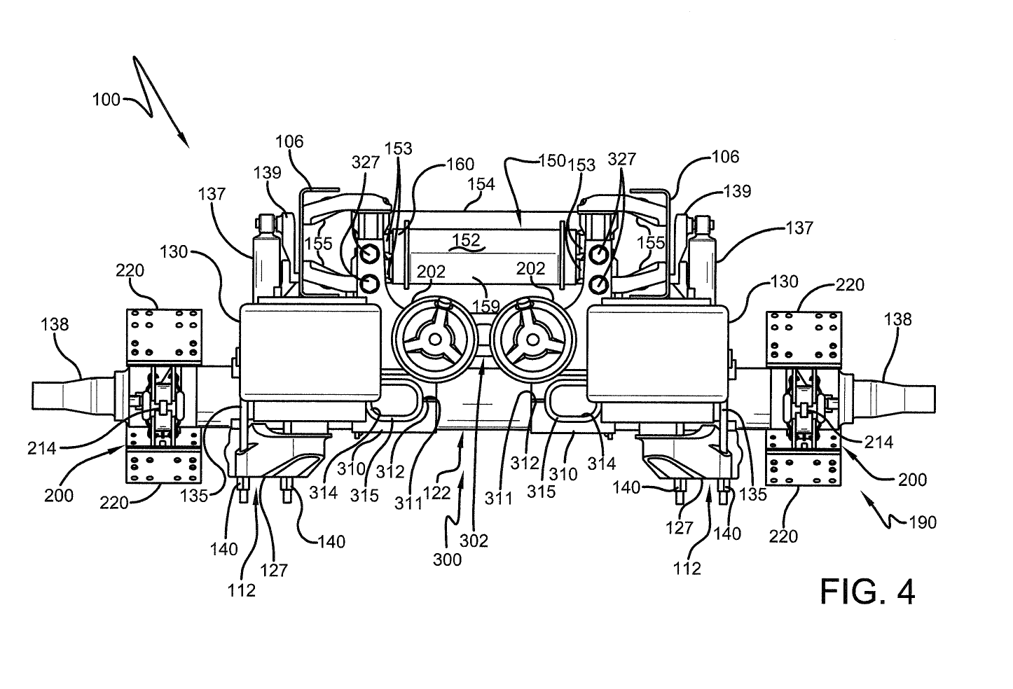

With reference to FIGS. 2-5, axle/suspension system 100 includes a torque box assembly 150. Torque box assembly 150 is of the type described and shown in U.S. Pat. No. 6,527,286, and assigned to Applicant of the present invention, Hendrickson U.S.A., L.L.C. Torque box assembly 150 includes a body 152 and a cross member 154. Body 152 includes a first hollow steel tube 160 welded to the front end of the body. With reference to FIGS. 2 and 4, a second hollow steel tube 159 is welded to the rearward end of body 152. A bonded rubber bushing 153 is inserted into each outboard end of first tube 160 and second tube 159. A metal rod (not shown) is disposed transversely through each of first hollow steel tube 160 and second hollow steel tube 159, as well as their respective bonded rubber bushings 153, so that a portion of the rod extends outboardly of each tube. Each rod end (not shown) extending outboardly from first hollow steel tube 160 is pivotally connected to cross member 154 in a manner known in the art. As is best shown in FIGS. 2-3, a pair of gussets 155 are attached to each outboard end of cross member 154 by a plurality of bolts 156. Each pair of gussets 155 are in turn attached to the inboard surface of their respective main member 106 by suitable means to secure torque box assembly 150 to the vehicle frame. Both ends of the rod (not shown) extending outboardly from second hollow steel tube 159 are connected to preferred embodiment integrated axle/suspension system tower mount 300 of the present invention, as will be described in greater detail below. Torque box assembly 150 reacts to vertical air spring loads, resists braking/acceleration loads, acts as the core roll resisting feature, resists cornering or lateral loading, maintains axle location in relation to vehicle main members 106, and helps prevent undue yaw and axle wind-up, as is known in the art.

Additionally, it may be desired in some heavy-duty vehicle applications to incorporate a second axle/suspension system forwardly of axle/suspension system 100, such as in a tandem axle/suspension configuration. In such cases, a second torque box assembly (not shown) similar to torque box assembly 150 can be attached to cross member 154 forward of the attachment of the torque box assembly to the cross member, with the second torque box assembly in turn being connected to a second axle (not shown) of a second axle/suspension system.

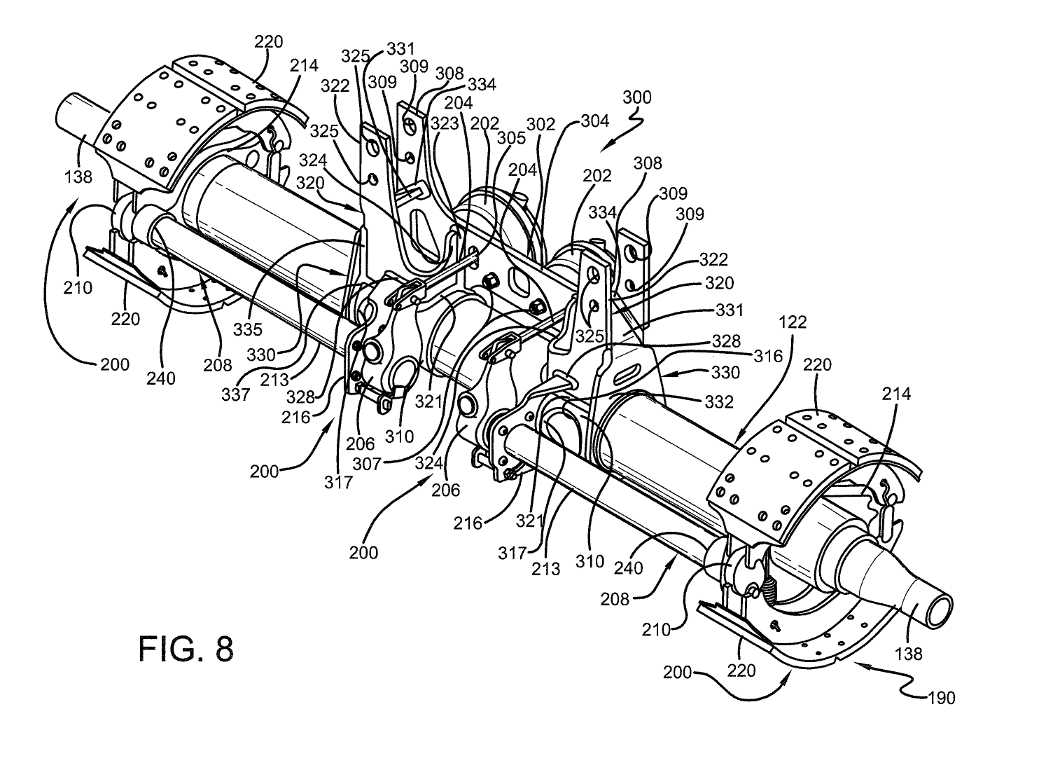

With reference to FIG. 8, preferred embodiment integrated axle/suspension tower mount 300 is formed of a sturdy metal, such as steel, and generally includes a brake air chamber/torque box assembly mounting bracket 302, a pair of torque box mounting brackets 320, a pair of support members 330, and a pair of axle wraps 310.

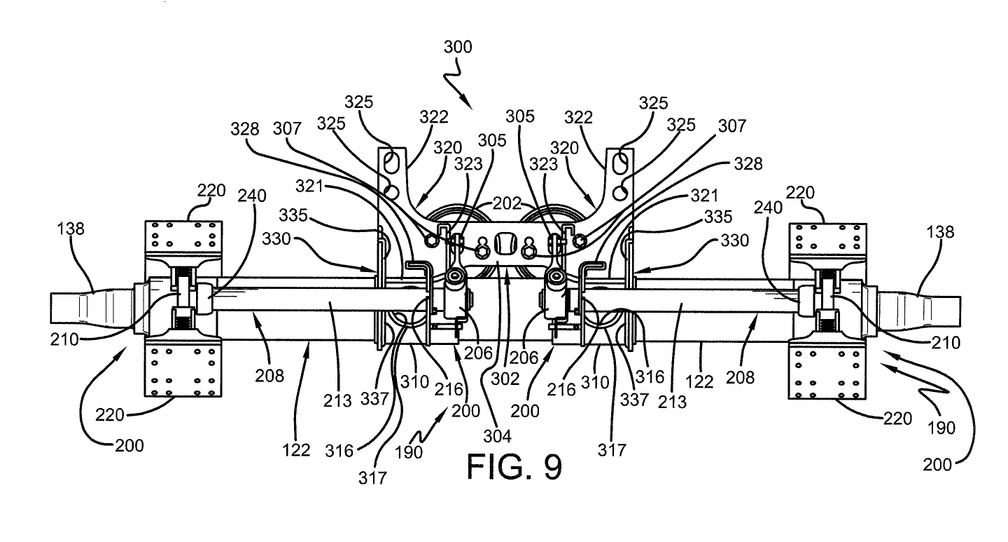

With reference to FIGS. 8 and 9, brake air chamber/torque box assembly mounting bracket 302 of axle/suspension system tower mount 300 is generally U-shaped and includes a transversely extending brake air chamber mounting portion 304. Brake air chamber/torque box assembly mounting bracket 302 also includes a pair of upwardly extending torque box assembly mounting portions 308. The pair of upwardly extending torque box assembly mounting portions 308 are integrally formed with brake air chamber mounting portion 304 on opposite outboard sides of the brake air chamber mounting portion. Each upwardly extending torque box assembly mounting portion 308 is formed with a pair of vertically aligned openings 309. Brake air chamber mounting portion 304 is rigidly attached to each axle wrap 310 by welds 303.

With continued reference to FIGS. 8 and 9, each torque box assembly mounting bracket 320 of axle/suspension system tower mount 300 includes an upwardly extending torque box assembly mounting portion 322. A rearwardly extending portion 324 is integrally formed with each torque box assembly mounting portion 302. A continuous weld 321 is laid between axle wrap 310 and the bottom edges of upwardly extending torque box assembly mounting portion 322 and rearwardly extending portion 324 to rigidly attach torque box mounting bracket 320 to the axle wrap. Rearwardly extending portion 324 is also rigidly attached at its rearwardmost edge to the forward facing surface of brake air chamber mounting portion 304 of brake air chamber/torque box assembly mounting bracket 302 by a weld 323. Weld 323 is a two-part weld, with a first pass being performed on one side of rearwardly extending portion 324 and a second pass being performed on the opposite side of the rearwardly extending portion, both passes slightly overlapping on the top of the rearwardly extending portion. Upwardly extending torque assembly mounting portion 322 is formed with a pair of vertically aligned openings 325. Vertically aligned openings 325 are longitudinally aligned with the pair of vertically aligned openings 309 of upwardly extending torque assembly mounting portion 308, and together enable attachment of torque box assembly 150 to preferred embodiment axle/suspension system tower mount 300, as will be described in greater detail below.

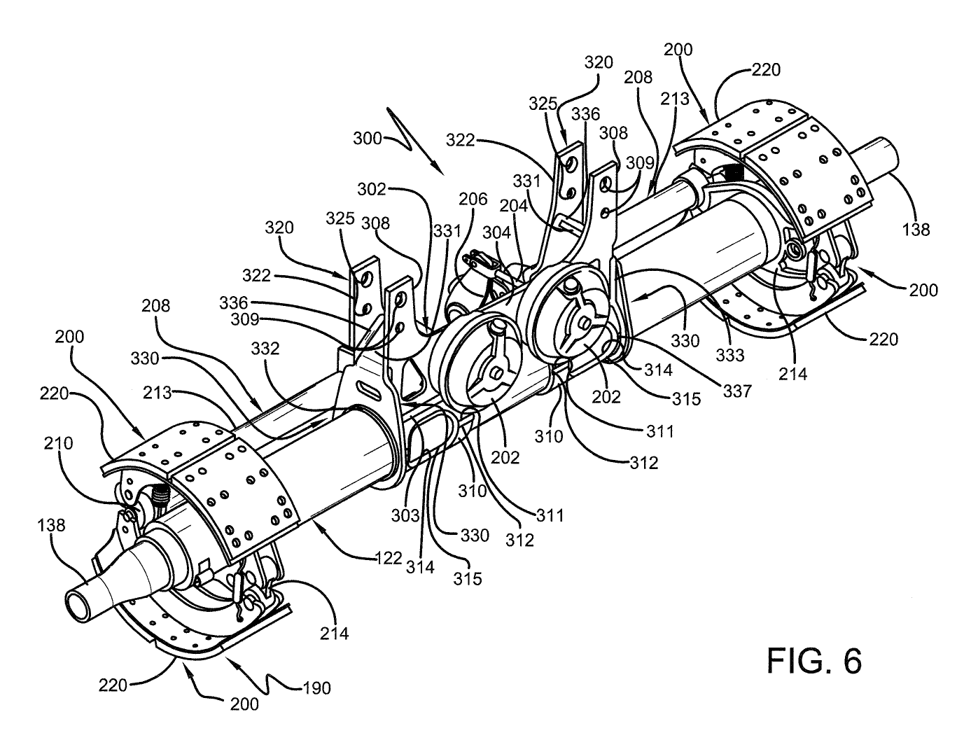

With particular reference to FIGS. 6-9, each support member 330 of axle/suspension system tower mount 300 is formed with an opening 332. Opening 332 has a diameter slightly larger than axle wrap 310. Each support member opening 332 is disposed around a respective axle wrap 310 so that the support members are positioned on opposite outboard ends of axle/suspension tower mount 300. More specifically, each support member 330 contacts the outboard edges of its respective torque box assembly mounting bracket 320 and brake air chamber/torque box assembly mounting bracket 302. With particular reference to FIGS. 6 and 8, the inboard facing surface of each support member 330 is rigidly attached to the outboard edges of its respective brake air chamber/torque box assembly mounting bracket 302 and torque box assembly mounting bracket 320 by welds 333 and 335, respectively. In addition, each support member 330 is attached to its respective axle wrap 310 by a circumferential weld 337. Support member 330 is integrally formed with a lateral support structure 331. Lateral support structure 331 extends angularly upwardly and inboardly from support member 330 and is positioned between, and secured to, the forward facing surface of upwardly extending torque box assembly mounting portion 308 of brake air chamber/torque box assembly mounting bracket 302 and the rearward facing surface of upwardly extending torque assembly mounting portion 322 of torque box mounting bracket 320, by welds 334 and 336, respectively. Lateral support structure 331 of support member 330 provides rigid lateral support between brake air chamber/torque box assembly mounting bracket 302 and torque box mounting bracket 320, as well outboard support to preferred embodiment axle/suspension system tower mount 300.

With reference to FIG. 2, preferred embodiment integrated axle/suspension system tower mount 300 of the present invention mounts torque box assembly 150 to axle 122. More, specifically, preferred embodiment axle/suspension system tower mount 300 includes a two-piece axle bracket bar pin clamp 326. Bracket bar pin clamp 326 is disposed between upwardly extending torque assembly mounting portion 322 of torque box mounting bracket 320 and upwardly extending torque assembly mounting portion 308 of brake air chamber/torque box assembly mounting bracket 302. Axle bracket bar pin clamp 326 is formed with a pair of vertically aligned longitudinal openings (not shown), which are longitudinally aligned with the pair of vertically aligned openings 325 of upwardly extending torque assembly mounting portion 322 and the pair of vertically aligned openings 309 of upwardly extending torque assembly mounting portion 308. The outwardly extending ends (not shown) of the metal rod (not shown) extending from second hollow steel tube 159 of torque box assembly 150 is disposed between, and housed within, each respective axle bracket bar pin clamp 326. A pair of fasteners 327 each are disposed through a respective one of vertically aligned openings 309, axle bracket bar pin clamp 326 vertically aligned longitudinal openings, and vertically aligned openings 325, and secure the outboard rod ends of torque box assembly 150 between/within upwardly extending torque assembly mounting portion 308, bar pin clamp 326, and upwardly extending torque assembly mounting portion 322. Housing of the outboardly extending ends of the metal rods (not shown) within bar pin clamp 126 provides pivotal connection of torque box assembly 150 to preferred embodiment axle/suspension system tower mount 300, which in turn is attached to axle 122, as will now be described.

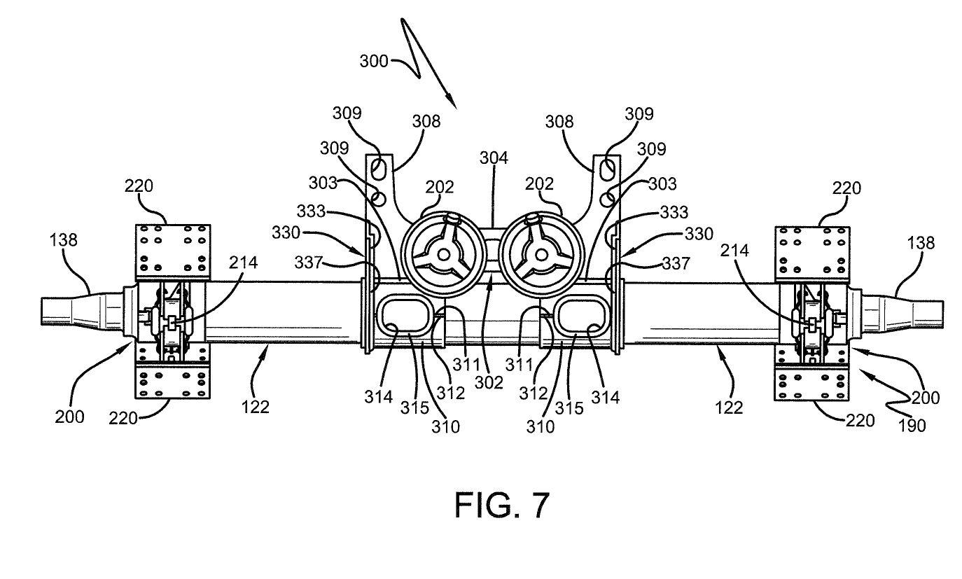

In accordance with an important feature of the preferred embodiment integrated axle/suspension system tower mount of the present invention, and with reference to FIGS. 7-9, axle/suspension system tower mount 300 is secured to axle 122 by pair of axle wraps 310. Inasmuch as axle wraps 310 are similar in structure, for purposes of conciseness, only a single axle wrap will now be described in detail. Axle wrap 310 is a generally rectangular shaped flat piece of metal, which is formed substantially completely around axle 122 in a manner well known in the art. A weld 312 is laid along the edges of a seam 311 of axle wrap 310 in order to secure the edges of the wrap to one another. It should be understood that axle wrap 310 could also be formed from a tube having an inner diameter equal to or slightly larger in diameter than the outer diameter of axle 122. In such an instance, axle wrap 310 is cut to size and then slip fit over the end of axle 122 without the need to weld a seam or the ends of the wrap together.

Axle wrap 310 is formed with a rearwardly facing oval weld opening 314. With particular reference to FIG. 7, a circumferential continuous window weld 315 is laid between axle wrap 310 and axle 122 around oval weld opening 314. With particular reference to FIG. 9, axle wrap 310 is also formed with a forwardly facing circular weld opening 316. A circumferential continuous window weld 317 is laid between axle wrap 310 and axle 122 around circular opening 316. Together, window weld 315 and window weld 317 rigidly secure axle wrap 310 to axle 122, while minimizing stress on axle 122. More specifically, because window welds 315 and 317 are continuous and curved, and are located at the generally lower stress front and rear quadrant locations on axle 122, as opposed to the generally higher stress bottom portion of the axle, formation of stress risers as a result of the welding process is minimized, which reduces axle stress as compared to rigid attachment of the wrap to the axle by circumferentially welding the outboard and/or inboard ends of the axle wrap to the axle, as is known by those with skill in the art.

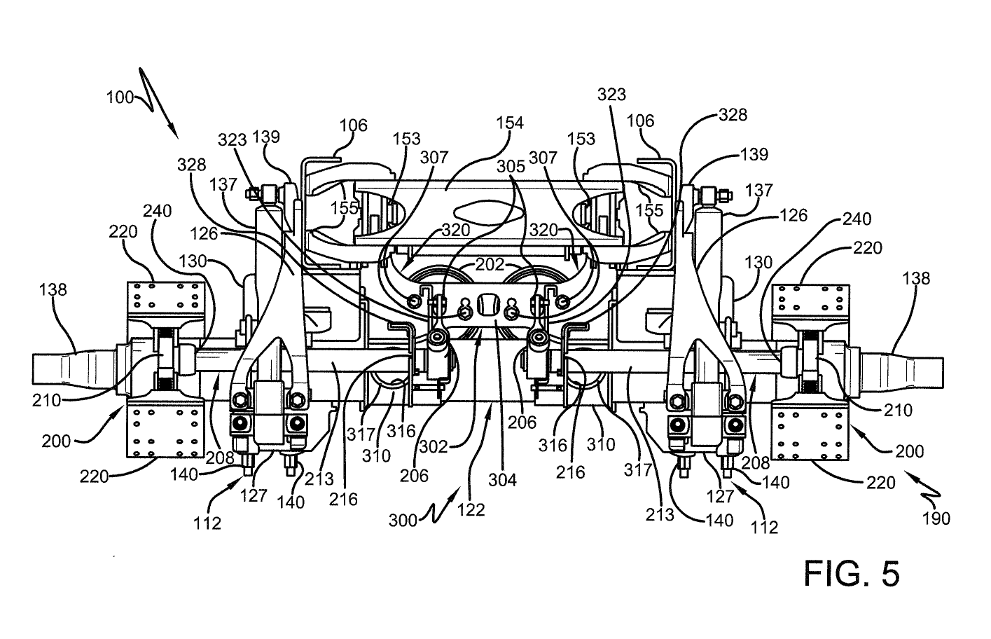

In accordance with another important feature of preferred embodiment integrated axle/suspension tower mount of the present invention, axle/suspension system tower mount 300 provides a mounting structure for mounting/integrating components and bracketing of an air brake system 190 on the tower mount, as will now be described. With reference to FIGS. 5 and 8-9, air brake system 190 includes a pair of brake assemblies 200. Inasmuch as brake assemblies 200 have similar structures and perform similar operations, for purposes of conciseness, only the driver side brake assembly will be described herein. Brake assembly 200 generally includes a brake air chamber 202, a brake air chamber pushrod 204, a slack adjuster 206, a brake spider 214, and an S-cam assembly 208. S-cam assembly 208 is of the type described and shown in U.S. Pat. No. 7,537,224, and assigned to the Applicant of the present invention, Hendrickson U.S.A., L.L.C. S-cam assembly 208 includes a cam shaft (not shown) having an S-cam 210 immovably attached to the outboard end of the cam shaft. S-cam assembly 208 also includes a cam tube 213, which houses the cam shaft (not shown). Brake spider 214 is immovably mounted on axle 122 by any suitable means, such as welds. Brake spider 214 is formed with a bore 240 through which cam tube 213 is disposed and mounted in a manner known in the art. The cam shaft is disposed through and rotably mounted within an outboard and inboard bushing (not shown) situated within cam tube 213. A splined inboard end (not shown) of the cam shaft meshingly engages a corresponding splined interior surface (not shown) of slack adjuster 206. Slack adjuster 206 is pivotally attached at its upward end to brake air chamber pushrod 204, which in turn is operatively attached to brake air chamber 202 in a manner known in the art.

A cam shaft bracket 216 is rigidly secured to preferred embodiment integrated axle/suspension system tower mount 300. More specifically, cam shaft bracket 216 is rigidly secured to the front surface of upwardly extending portion 322 of torque box assembly mounting bracket 320 by a weld 328. Additionally, the rearward edge of cam shaft bracket 216 is correspondingly contoured and mates with the outer contour of axle wrap 310, and is rigidly secured to the axle wrap at the contoured mating by a weld (not shown). Cam shaft bracket 216 extends forwardly from its attachment to torque box assembly mounting bracket 320. Cam shaft bracket 216 is formed with a transverse opening through which cam tube 213 of air brake system 190 is disposed. Cam tube 213 is clamped or otherwise rigidly attached to cam shaft bracket 216. Cam shaft bracket 216 provides inboard support to Scam assembly 208. By rigidly attaching cam shaft bracket 216 directly to axle wrap 310 of axle/suspension system tower mount 300 by welds 328 and the weld between the outer contour of axle bracket 310 and contour of cam shaft bracket 216, the axle/suspension system tower mount of the present invention provides cam tub 213 inboard mounting support, while eliminating the need to weld the cam shaft bracket directly to axle 310, thereby further reducing axle stress.

In addition, preferred embodiment integrated axle/suspension system tower mount 300 supports the mounting of brake air chamber 202 of air brake system 190 on the tower mount. More specifically, brake air chamber mounting portion 304 is formed with a pair of brake air chamber pushrod openings 305. Brake air chamber mounting portion 304 is also formed with two pairs of transversely spaced mounting openings (not shown). Each pair of transversely spaced mounting openings (not shown) are positioned on brake air chamber mounting portion 304 so that a respective brake air chamber pushrod opening 305 is positioned between the transversely spaced mounting openings. As best shown in FIGS. 5 and 8, a pair of bolts 307 each are disposed through each respective ones of pair of transversely spaced mounting openings and secure a respective brake air chamber 202 to brake air chamber mounting portion 304. Brake air chambers 202 are mounted on brake air chamber mounting portion 304 so they extend rearwardly from their attachment to the brake air chamber mounting portion. Each brake air chamber pushrod 204 extends through its respective brake air chamber pushrod opening 305 and is operatively attached to slack adjuster 206 in the manner described above.

Together, attachment of preferred embodiment integrated axle/suspension system tower mount 300 of the present invention to axle 122 via axle wraps 310, mounting of torque box assembly 150 to the tower mount, and integration of brake system components of brake system 190 with the tower mount reduces axle stress by minimizing welds on the axle as compared to prior art non-torque reactive-type axle/suspension systems adapted for non-drive applications, enabling a lighter round axle to be utilized with axle/suspension system 100. With reference to FIGS. 2-9, axle 122, which is incorporated into axle/suspension system 100 by way of preferred embodiment integrated axle/suspension system tower mount 300 of the present invention, is a round axle. Axle 122 is formed of steel and has a diameter of about 5.75 inches. Axle 122 preferably has a diameter of about 4 inches to about 7 inches. More preferably, axle 122 has a diameter of about 5 inches to about 6 inches. Alternatively, axle 122 could be formed of aluminum, or other suitable materials and have different diameters and thicknesses, including non-uniform outer and/or non-uniform inner diameters, depending on the material of construction and desired use, while providing the same weight reduction benefits as those realized by the axle as incorporated into the non-drive non-torque reactive-type axle/suspension system 100.

An additional benefit of preferred embodiment integrated axle/suspension system tower mount 300 of the present is realized by the interaction of forces involved during vehicle braking with an air brake system, such as air brake system 190, and the manner in which brake system components of air brake system 190 are integrated with the tower mount, as will now be described. For purposes of conciseness, only the braking actuation and related forces of the driver side S-cam assembly 208 will be described, with the understanding that the passenger side S-cam assembly 208 functions in a similar manner. With reference to the driver side brake air chamber 202, when the brake air chamber is pneumatically actuated during vehicle braking, brake air chamber pushrod 204 is forced forwardly, which in turn causes counter-clockwise pivotal rotation of slack adjuster 206 about its connection to the cam shaft (not shown). Because the cam shaft (not shown) meshingly engages slack adjuster 206, it too is rotated counter-clockwise within the inboard and outboard cam tube bushings (not shown) of cam tube 213, which in turn provides for transfer of in-line loads from brake air chamber pushrod 204 into a torsional load on the cam shaft (not shown). As the cam shaft (not shown) is rotated, S-cam 210 also rotates counter-clockwise, forcing a pair of brake shoes 220 against a brake drum of the respective vehicle wheel, which in turn decelerates the vehicle.

The fabricated construction of preferred embodiment axle/suspension system tower mount 300 provides a sturdy and stable platform for mounting components of air brake system 300, which in turn provides improved performance to air brake system 190 More specifically, welding each rearwardly extending portion 324 of each torque box mounting bracket 320 to the forward surface of brake air chamber mounting portion 304 between the transversely spaced mounting openings through which each pair of bolts 307 attach a respective brake air chamber 202 to the brake air chamber mounting portion, and welding each lateral support structure 331 to its respective forward facing surface of upwardly extending torque box assembly mounting portion 308 of brake air chamber/torque box assembly mounting bracket 302, creates four stiffening points on brake air chamber/torque box assembly mounting bracket 302, which adds stability to preferred embodiment axle/suspension system tower mount 300. This in turn prevents brake air chamber/torque box assembly mounting bracket 302 from bending out of its transverse plane from the rearward force on brake air chamber 202 when the brake air chamber counteracts to the forward force of pushrod 204 during brake actuation.

Furthermore, because cam shaft bracket 216 and brake air chambers 202 are integrated/mounted on axle/suspension system tower mount 300 between attachments of torque box assembly 150 and on the stable structure of the tower mount, deflection of cam shaft bracket 216 is significantly reduced under high application pressure, for example, at 100 psi. This in turn limits pushrod 204 stroke compared to prior art non-torque reactive-type axle/suspension systems in which the air brake system components are attached to the axle outboardly of attachment of the axle to the torque box assembly. In addition, the longitudinal positioning of cam shaft bracket 216 to brake air chambers 202 as integrated/mounted on axle/suspension system tower mount 300 limits stroke between the brake air chamber and slack adjuster 206. Also, because cam shaft bracket 216 is connected directly to axle/suspension system tower mount 300 adjacent to the longitudinal center line of axle/suspension system 100, additional stability is provided to the inboard end of S-cam assembly 208, which in turn provides stability to the entire air brake assembly 200. Although mounting of cam shaft brackets 216 and brake air chambers 202 adjacent to the center of axle 122 increases the required length of the cam shaft (not shown), the increased stability of brake system 190, including the decreased deflection of brake system components, experienced from integration of the brake system into axle/suspension system tower mount 300 compensates for the additional torsional twist in the longer cam, enabling efficient performance of the brake air chamber by avoiding stroking into the reduced efficient longer stroke range of brake air chamber 202. Consequently, the manner in which components of air brake system 190, including brake air chambers 202 and cam shaft brackets 216, are integrated into preferred embodiment axle/suspension system tower mount 300 results in a more responsive and fade resistant S-cam brake actuation structure, which provides overall improved brake system performance to the air brake system.

It is understood that axle/suspension system tower mount 300 of the present invention can be utilized on heavy-duty tractors, as well as other vehicles such as heavy-duty trucks or even trailers without affecting the overall concept of the invention. It is also understood that axle/suspension system tower mount 300 of the present invention could be utilized in both trailing arm and leading arm axle/suspension system configurations for heavy-duty vehicles, without affecting the overall concept of the invention. It is also understood that tower mount 300 could find application in axle/suspension systems having different structures and arrangements of their various components than those shown and described herein, including those utilizing different hangers, air springs, shock absorbers, axle-to-torque arm connections, non-air-ride axle/suspension systems, and the like. It is further understood that tower mount 300, and components thereof, could be formed with different structures/components, or of other materials, including aluminum, composites, or other suitable materials, without affecting the overall concept of the invention. It is also understood that tower mount 300 could enable/support attachment of additional or different vehicle components than those described, such as different brake configurations, including different air brake system components, or different torque box assemblies, without affecting the overall concept of the invention. It should be understood that other types of either continuous or non-continuous welds could also be utilized to attach wraps 310 to axle 122 and/or to attach/integrate the various components of tower mount 300, such as spot welds or segmented welds and the like, without changing the overall concept or function of the present invention. It is also understood that the components of tower mount 300 could be non-integrated without affecting the overall concept of the invention.

Accordingly, the axle/suspension system tower mount for heavy-duty vehicles of the present invention is simplified, provides an effective, safe, inexpensive, and efficient structure which achieves all the enumerated objectives, provides for eliminating difficulties encountered with prior art axle/suspension systems, and solves problems and obtains new results in the art.

In the foregoing description, certain terms have been used for brevity, clarity and understanding; but no unnecessary limitations are to be implied therefrom beyond the requirements of the prior art, because such terms are used for descriptive purposes and are intended to be broadly construed. Moreover, the present invention has been described with reference to a specific embodiment. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the improved mounting structure for axle/suspension systems of heavy-duty vehicles of the present invention is constructed, arranged and used, the characteristics of the construction and arrangement, and the advantageous, new and useful results obtained; the new and useful structures, devices, elements, arrangements, parts and combinations are set forth in the appended claims.

What is claimed is:

1. A mounting structure for a heavy-duty vehicle axle/suspension system and brake system comprising:
a) at least one axle wrap disposed about and rigidly attached to an axle of said vehicle axle/suspension system;
b) a mount assembly rigidly attached to said at least one axle wrap and being operatively connected to a force reacting suspension component of said axle/suspension system, said mount assembly providing a support structure for mounting at least one component of an air brake system.

2. The mounting structure for a heavy-duty vehicle axle/suspension system and brake system of claim 1, wherein said axle is a round axle.

3. The mounting structure for a heavy-duty vehicle axle/suspension system and brake system of claim 2, wherein said axle is formed of a material selected from the group consisting of aluminum and steel.

4. The mounting structure for a heavy-duty vehicle axle/suspension system and brake system of claim 2, wherein said axle preferably has a diameter of about 4 inches to 7 inches.

5. The mounting structure for a heavy-duty vehicle axle/suspension system and brake system of claim 2, wherein said axle more preferably has a diameter of about 5 inches to about 6 inches.

6. The mounting structure for a heavy-duty vehicle axle/suspension system and brake system of claim 1, wherein said force reacting suspension component is a torque box assembly, said torque box assembly being attached to a pair of frame main members of said heavy-duty vehicle.

7. The mounting structure for a heavy-duty vehicle axle/suspension system and brake system of claim 1, wherein said mount assembly is an integrated structure.

8. The mounting structure for a heavy-duty vehicle axle/suspension system and brake system of claim 1, wherein said mount assembly decreases deflection between a cam shaft and a brake air chamber.

9. The mounting structure for a heavy-duty vehicle axle/suspension system and brake system of claim 1, wherein said mount assembly is pivotally connected to said force reacting suspension component.

10. The mounting structure for a heavy-duty vehicle axle/suspension system and brake system of claim 1, wherein said one or more air brake system components includes at least one cam bracket attached to said mount assembly.

11. The mounting structure for a heavy-duty vehicle axle/suspension system and brake system of claim 10, wherein said one or more air brake system components further includes an S-cam assembly attached to said at least one cam bracket to provide inboard support to said S-cam assembly, the S-cam assembly being further attached to a brake spider attached to an outboard end of said axle, said brake spider providing outboard support to said S-cam assembly.

12. The mounting structure for a heavy-duty vehicle axle/suspension system and brake system of claim 11, wherein said one or more air brake system components further includes at least one brake air chamber attached to said mount assembly, said at least one brake air chamber being operatively connected to said S-cam assembly.

13. The mounting structure for a heavy-duty vehicle axle/suspension system and brake system of claim 12, wherein said mount assembly includes a brake air chamber mounting portion, at least one lateral support structure, and at least one torque mounting portion, said brake air chamber mounting portion and said at least one torque mounting portion being longitudinally spaced on and attached to said axle wrap, said at least one lateral support structure being disposed between and welded to the at least one torque mounting portion and the brake air chamber mounting portion to provide a first stiffening point on said brake air chamber mounting portion, said at least one brake air chamber being attached to the brake air chamber mounting portion with a pair of fasteners, said at least one cam bracket being attached to said at least one torque mounting portion, the at least one torque mounting portion being welded to said brake air chamber mounting portion between said pair of fasteners to provide a second stiffing point on the brake air chamber mounting portion, said first and said second stiffening points providing stability to said mount assembly and preventing said brake air chamber mounting portion from bending out of a transverse plane when the at least one brake air chamber and said S-cam assembly operatively communicate.

14. The mounting structure for a heavy-duty vehicle axle/suspension system and brake system of claim 1, wherein said at least one axle wrap is rigidly attached to said axle by welding.

15. The mounting structure for a heavy-duty vehicle axle/suspension system and brake system of claim 1, wherein said at least one axle wrap includes at least one opening, the at least one axle wrap being rigidly attached to said axle by a circumferential window weld laid between said at least one opening and said axle.
